(19) United States
(12) Patent Application Publication
(10) Pub. No.: US 2011/0185551 A1
(43) Pub. Date: Aug. 4, 2011

(54) METHOD OF INSTALLATION OF POWER STEERING APPARATUS

(76) Inventors: Neil Raymond Oakley, East Sussex (GB); Gabriella Oakley, East Sussex (GB)

(21) Appl. No.: 13/055,664

(22) PCT Filed: Jul. 17, 2009
(86) PCT No.: PCT/GB2009/001778

§ 371 Date: Apr. 20, 2011

(30) Foreign Application Priority Data
Jul. 24, 2008 (GB) 0813572.5

(51) Int. Cl. B23P 17/00

(52) U.S. Cl. 29/401.1

(57) ABSTRACT

A method of installing a power steering apparatus into a vehicle using the original steering box includes the steps of first fabricating a frame to support the power steering apparatus. The power steering apparatus is then linked to the original steering box of the vehicle, and a frame is fabricated to support the power steering apparatus. The power steering apparatus is fitted to the frame and the frame is fixed to the vehicle.

### BACKGROUND OF THE INVENTION

The present invention relates to a method of installation of power a steering apparatus into an existing vehicle.

Power steering now comes as standard in the majority of new vehicles. Older vehicles without a power steering system can be difficult to drive, especially to a person used to power steering. Larger vehicles, such as Volkswagen® Camper Vans, are particularly difficult to steer, particularly for an elderly person.

Applicant seeks to provide a method of installation of a power steering apparatus into an existing vehicle. The method of installation has the benefit of fitting into the original steering box of the vehicle so as to not damage the vehicle's integrity, crucial with vehicles having an iconic status such as Volkswagen® camper vans.

### SUMMARY OF THE INVENTION

The present invention teaches certain benefits in construction and use which give rise to the objectives described below.

The present invention provides a method of installing a power steering apparatus to a existing vehicle without such apparatus, the method comprising the steps of: removing the original steering column of the vehicle; linking the power steering system to the original steering box of the vehicle; fabricating a frame to support the power steering apparatus; fitting the power steering apparatus to the frame; and fixing the frame to the vehicle.

### BRIEF DESCRIPTION OF THE DRAWINGS

One embodiment of the invention will now be described by way of example only with reference to the accompanying figures in which:

FIG. 1 is a schematic view of a power steering apparatus that has been installed in accordance with one embodiment of the invention;

FIG. 2 is a blown up view of an upper bracket of the apparatus of FIG. 1;

FIG. 3 is a view of FIG. 2 from its reverse side; and

FIG. 4 is a blown up view of the lower bracket of the apparatus of FIG. 1.

### DETAILED DESCRIPTION OF THE INVENTION

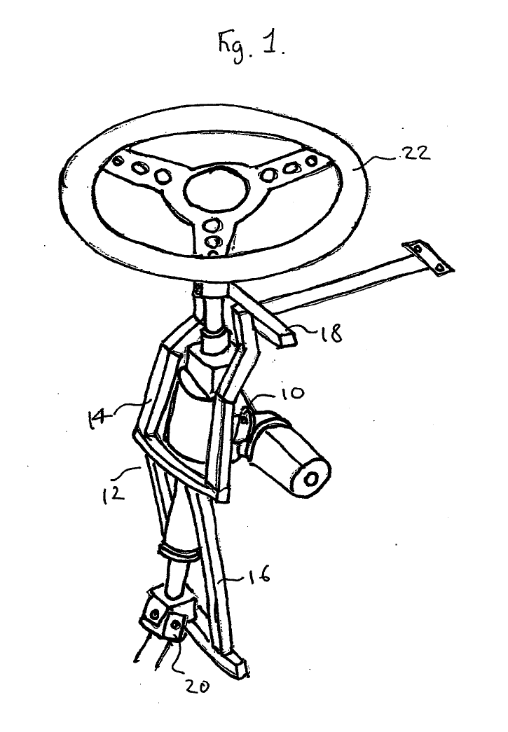

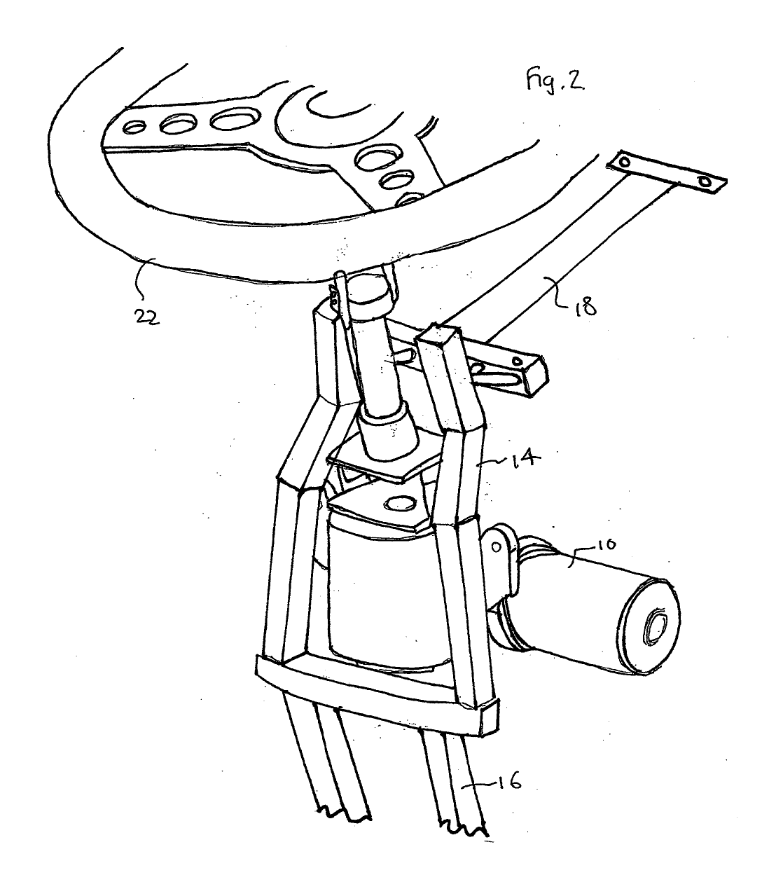

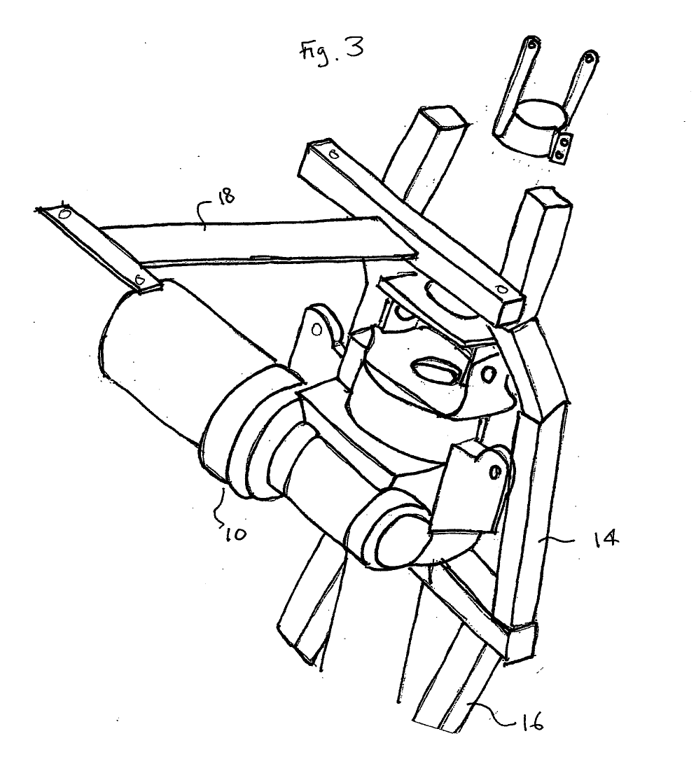

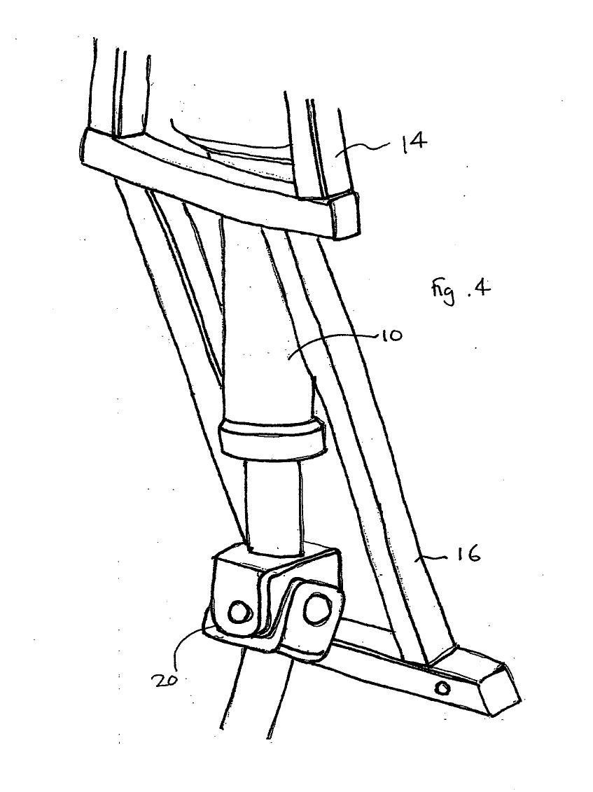

FIG. 1 shows the power steering apparatus 10 once installed, and FIG. 2 is a blown up view of an upper bracket of the apparatus of FIG. 1. FIG. 3 is a view of FIG. 2 from its reverse side, and FIG. 4 is a blown up view thereof.

As illustrated in FIGS. 1-4, the power steering apparatus 10 is held within a retaining frame 12 which is formed of upper and lower brackets 14, 16. The lower bracket 16 is bolted to the vehicle (not shown). The upper bracket is 14 is also bolted to the vehicle via a further connecting bracket 18.

The retaining frame 12 holds the power steering apparatus 10 in place allowing it to be used with the original steering box of the vehicle.

The power steering apparatus 10 itself is a standard unit supplied by the vehicle manufacturers and does form part of the invention per se.

The method of installation of the power steering apparatus 10 will now be described.

Firstly original components of the steering unit of the vehicle are removed. This initially involves the removal of the original steering lock and switch brackets. The original steering column is then removed. The original ignition switch is removed and fitted to a new bracket.

As can be seen in FIG. 4, the power steering apparatus 10 is then fixed to the original steering box by milling the lower constant velocity joint 20 to receive the original steering box.

New steering lock and switch brackets are then fabricated before the supply wiring directly from the 30A battery/starter is installed.

The upper and lower brackets 14, 16 are then fabricated and bolted together to form the retaining frame 12. The connecting bracket 18 is bolted to the upper bracket 14. The power steering apparatus 10 is fitted to the frame 12 which is then bolted to the vehicle using the original mounting holes underneath the dashboard.

The lower steering column surround is then modified to accept a CV gator.

Apertures are drilled in the front panel of the vehicle to bolt the lower bracket 16 to the vehicle floor.

A variable control power control unit (not shown) is fitted under the dashboard and a control switch is fitted on the dashboard which has been designed to suit the user.

Finally, the original steering wheel 22 is fitted.

The method described has been carefully developed to at all times retain the integrity of the vehicle. No welding is required, rather the retaining frame 12 is bolted to the vehicle interior to hold the power steering apparatus in place. Consequently, the method does not involve any irreversible modification to the vehicle structure.

The above described embodiment has been given by way of example only, and the skilled reader will naturally appreciate that many variations could be made thereto without departing from the scope of the present invention.

1. A method of installing a power steering apparatus to a existing vehicle without such apparatus, the method comprising the steps of:
removing the original steering column of the vehicle;
linking the power steering system to the original steering box of the vehicle;
fabricating a frame to support the power steering apparatus;
fitting the power steering apparatus to the frame; and
fixing the frame to the vehicle.

2. A method according to claim 1, further comprising the step of removing the original ignition circuit and fitting the circuit to a new bracket.

3. A method according to claim 2, further comprising the step of fitting variable power control unit on the dashboard of the vehicle.

4. A method according to claim 3, further comprising modifying the lower steering column surround to accept a CV gator.

5. A method according to any one of claims 1 to 4, further comprising the final step of fitting the original steering wheel to the steering column.

6. A frame fabricated to support a power steering system installed in accordance with the method of claim 1, the frame being connected to a surface of a vehicle in which the power steering apparatus is installed.

7. A frame according to claim 6, comprising upper and lower brackets, the lower bracket being bolted directly to the vehicle and the upper bracket being bolted to the vehicle via a further connecting bracket.

8. A method of installing a power steering apparatus as hereinbefore described and referred to in the accompanying figures.
